(19) United States
(12) Patent Application Publication
(10) Pub. No.: US 2010/0044982 A1
(43) Pub. Date: Feb. 25, 2010

(54) Shopping Cart With Modular Reusable Containers

(76) Inventor: Vered Meiri, Herzelya (IL)

Correspondence Address: The Law Office of Michael E. Kondoudis, 888 16th Street, N.W., Suite 800, Washington, DC, 20006, US

(21) Appl. No.: 12/197,362

(22) Filed: Aug. 25, 2008

(51) Int. Cl. B62D 39/00

(52) U.S. Cl. 280/33.992

(57) ABSTRACT

A system comprising a shopping cart and a multiplicity of modular and reusable containers, where the containers can be placed upon the shopping cart and removed from the shopping cart by a customer, according to the customer's needs. The containers have an encircling wall and a floor connected thereto, where the wall has protruding and sunken parts forming a shape that enables compactly stacking the containers, where each two adjacent containers are engaged in an interlocking manner.

### FIELD OF THE INVENTION

The present invention relates generally to the field of containers and more particularly to containers for shopping carts.

### BACKGROUND OF THE INVENTION

When shopping in a shopping facility such as a supermarket, for instance, many customers use shopping carts, to help them carry the products they wish to buy. Usually some of the products are placed in plastic bags to allow the customers to sort the products and carry them when leaving the facility, since the customers are required to leave the cart when leaving the area of the shopping facility.

Many customers place some of the products in the cart and only sort and place them into bags after passing through the cashier station, where their products are passed and paid for.

Most of those plastic bags used by customers are then thrown or reused once or twice before they too are thrown. This customers' shopping behavior is extremely popular and practiced all over the world on daily basis. This means that millions and millions of plastic bags are being used and manufactured for that purpose. Since plastic bags take many years to naturally decompose this behavior is dangerous to our planet.

Fabric bags (baskets) are now offered to customers but they are too large to contain sorted products and may end in containing too many heavy products, which may be difficult for carrying.

Alternatively, paper bags are replacing the plastic ones in some areas of the world but it can be extremely uncomfortable to place wet packages (such as milk cartons and frozen products) in them since the paper does not hold those products very well, since it can easily become wet and infirm.

### SUMMARY OF THE INVENTION

The present invention, in some embodiments thereof, provides customers of shopping facilities with a system that comprises a shopping cart and a multiplicity of modular and reusable containers. The customers may use the system to place products they select while shopping in the containers that are in the cart and select the number and size of containers according to their products and needs.

According to some embodiments of the invention, the containers can be mounted on said cart and removed from said cart, according to the customer's needs.

According to some embodiments of the invention, the modular containers may enable the customer to one of: pile the containers one on top of another creating columns and/or couple place same adjacent to one another in a compacted manner creating rows.

The containers may be reusable and modular enabling to engage with one another in a compact manner creating a stack of at least two rows and at least two columns of containers.

According to some embodiments of the invention, each of said containers may comprise a wall and a floor integrally connected to said wall, where said wall comprises protruding parts and at least one sunken part. The sunken part of a first container enables receiving at least one of the protruding parts of a second container when said first and second containers are placed adjacent to one another in a row, thereby enabling the adjacent containers to engage in an interlocking manner when placed adjacent to one another as the stack in the shopping cart.

According to some embodiments of the invention, container may have an upper rim defined by the main opening of the container. Additionally, each container may further comprise niches, which are situated at the lower edge of the container, opposite to said rim, where said niches enable interlocking two adjacent containers placed one on top of the other in an opposite direction, meaning that while the upper container faces one direction the other container faces the opposite direction opposite in substantially 180 degrees.

According to some embodiments of the invention, the wall of each container may be curved where the protruding parts and the at least one sunken part are defined by said curve, where said wall defines an upper rim, which is curved according to the curvature of the wall. Additionally, the sunken part of each container created between two or more protruding parts, enables receiving at least one of the protruding parts of another container when said containers are placed adjacent to one another, thereby enabling the adjacent containers to engage in an interlocking manner.

According to some embodiments of the invention, the shopping cart may be compatible to carry one or more specific designs of containers. The shopping cart may comprise: a frame comprising the wheels; a base mounted on the frame; handle-frame mounted to the frame to the base, enabling the customer to roll the shopping cart by pushing the handle-frame; and at least one support stretching along the handle-frame and connecting to the base.

According to some embodiments of the invention, the curvature of the surface of the support may be compatible to the curvature of the surface of the containers that are adjacent to the support in a manner that allows those adjacent curvatures of the containers and support to engage.

According to some embodiments of the invention, the curvature of the wall of each container may be kidney shaped where two protruding parts create a sunken part there-between.

According to some embodiments of the invention, each container may further comprise at least one handle connected thereto enabling the customer to hold the container with said at least one handle.

According to some embodiments of the invention, each container may be made from solid and waterproof materials enabling to maintain its shape and hold products therein as well as to hold wet products. For example, the containers may be made from plastic, which is both solid and waterproof.

According to some embodiments of the invention, the containers may have different sizes enabling the customer to select the size of the container according to his needs and stack different sizes of containers to one another in a compacted manner.

According to some embodiments of the invention, at least some of said containers may comprise barcode reader, which is a device that enables reading the barcode indicated on products in the shopping facility. The barcode reader may enable the customer to input his credit card details so that the charging for the customer's products placed in the containers is carried out automatically and electronically through said reader.

According to some embodiments of the invention, the system may further comprise fastening means that enable fastening containers that are situated adjacent to the shopping cart to said shopping cart and/or to one another.

According to some embodiments of the invention, the fastening means (e.g. Velcro stripes) may be are attached to the walls of the containers enabling to attach adjacent containers in a row to one another.

According to some embodiments of the invention, at least some of the containers may comprise at least one opening situated at one of the sides of the container that faces the external side of the stack when placed in the cart, to allow the customer to insert products into the container through said opening. The container may further comprise a door attached to said opening, which allows the customer to close and open the opening according to his needs.

According to some embodiments of the invention, the external bottom side of each container may further comprise slits where the base of the shopping cart may comprise corresponding protruding tracks wherein the slits enable receiving the protruding tracks and thereby hold the bottom rows of containers placed on said base.

According to some embodiments of the invention, at least some of said containers may be used as an advertising tool, wherein the containers carry advertising content thereon (e.g. by having advertisements painted thereon, adhered thereto and the like).

According to some embodiments of the invention, each pair of adjacent rows in the stack placed one on top of the other, has containers that are facing opposite directions alternatively along the stack, wherein the containers of one row face one direction and the container of the adjacent row face the opposite direction.

According to some embodiments of the invention, the containers may further comprise a mechanism for receiving coins that allow renting each of the containers.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein:

FIG. 1A is a schematic illustration of a system of a shopping cart with modular reusable containers, according to some embodiments of the invention;

FIG. 1B is a front side view of a reusable container for shopping carts, according to some embodiments of the invention;

FIG. 2 is a schematic illustration of a system of a shopping cart with modular reusable containers, according to other embodiments of the invention; and

FIG. 3A and FIG. 3B are schematic illustrations of front and back isometric views of a modular reusable container for shopping carts, respectively, according to some embodiments of the invention.

The drawings together with the description make apparent to those skilled in the art how the invention may be embodied in practice.

### DETAILED DESCRIPTIONS OF SOME EMBODIMENTS OF THE INVENTION

The present invention, in some embodiments thereof, provides modular reusable containers 10 for a shopping cart 100, where the modular reusable containers 10 that can be mounted to the cart 100 according to a customer's needs.

The shopping cart 100 referred to in this document, may be any shopping cart known in the art that is used in shopping facilities such as supermarkets, for mounting and carrying of goods (products). Shopping carts are the devices also known in the art as trolleys, bascarts, carriages and the like.

Additionally or alternatively, the shopping cart 100 may be customized to suit the design of the containers 10 and to allow holding the containers 10 in a stabilized manner and/or in a manner that enables fastening to at least some of the containers 10 mounted thereon.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

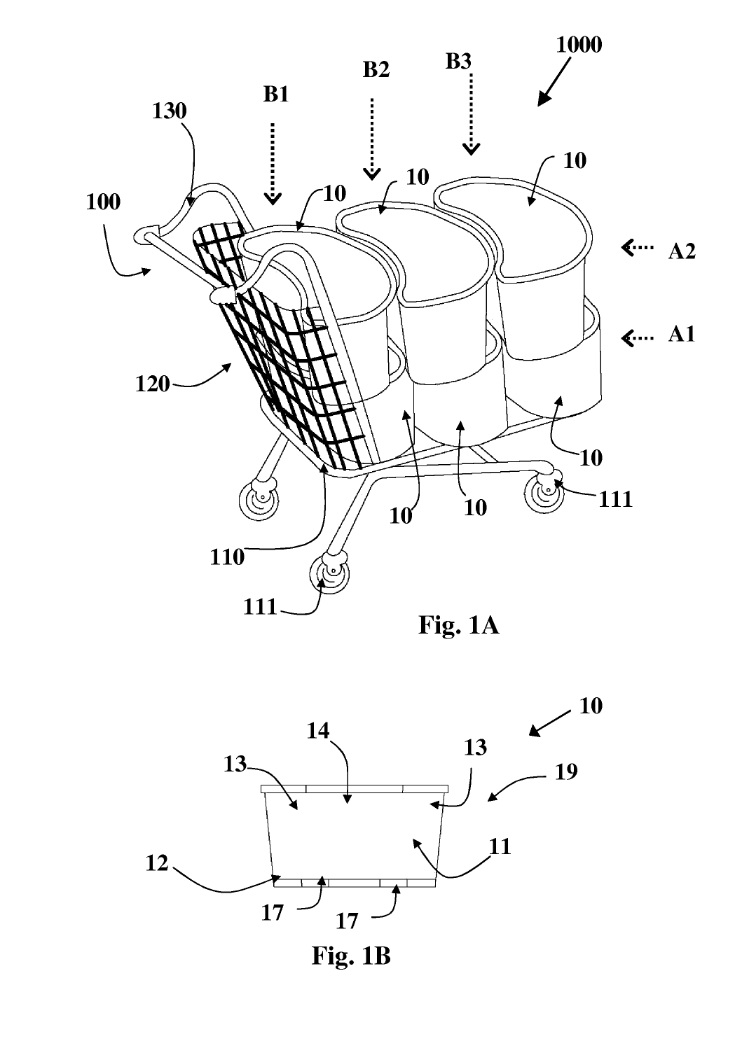

FIG. 1A schematically illustrates a system 1000 comprising a shopping cart 100 and a multiplicity of modular reusable containers 10. According to some embodiments of the invention, the containers 10 may be designed in such a manner that allows them to interlock in rows A1 and A2, where the containers 10 of each pair of adjacent rows A1 and A2 face opposite directions alternatively (meaning that they are substantially turned 180 degrees from one another).

Accordingly, each pair of adjacent rows such as A1 and A2 may have containers 10 that are facing opposite directions alternatively along the stack, where the containers 10 in the same row may be interlocked by facing the same direction, as shown in FIG. 1A.

FIG. 1B is a front side view of a reusable container 10 for shopping carts 100, according to some embodiments of the invention. The container 10 may comprise a curved wall 11, which is the circumference encircling the container 10, which may be kidney shaped and a floor 12. According to some embodiments of the invention, the shape of the container 10 may comprise protruding parts 13 and sunken parts 14 that may allow the containers 10 to engage in an interlocking manner when placed in a row one closely or tightly adjacent to another.

The protruding parts 13 and sunken parts 14 of the container's wall 11 may define the shape of an upper rim 19, defining the main opening of the container 10, which may slightly protrude defining the curvature of the top view of the container 10 (e.g. the kidney shape), where the other edge of the wall 11 adjacent to the floor 12 may comprise niches 17 that may enable receiving the rim 19 of a container 10 placed underneath. The niches 17 shape and positioning may fit to allow placing the container 10 in an opposite direction to the container 10 below it and thereby mesh with that rim 19, as illustrated in FIG. 1a.

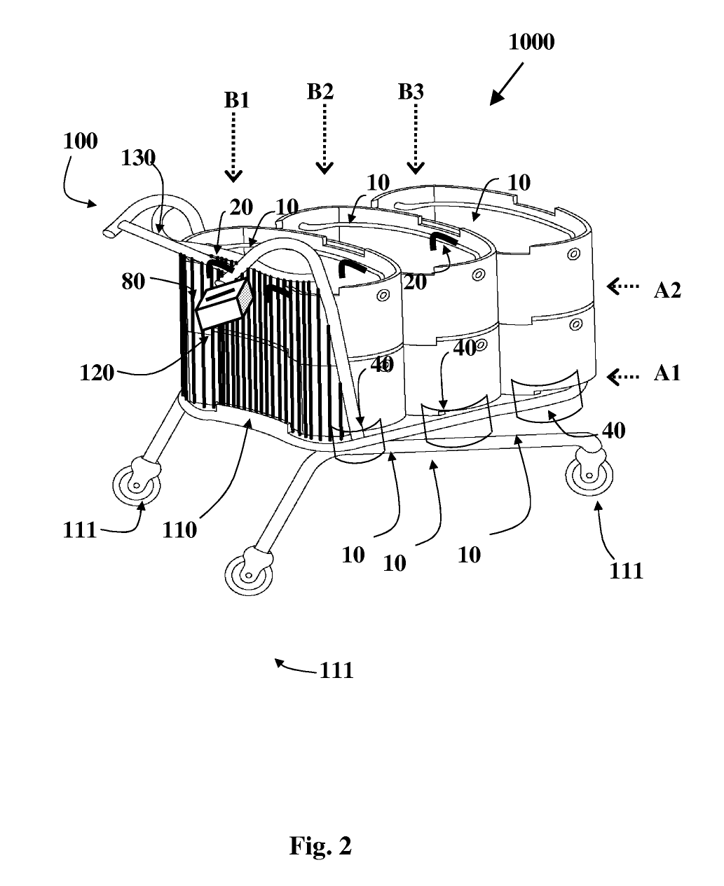

FIG. 2 is a schematic illustration of a system 1000 of a shopping cart 100 with modular reusable containers 10, according to some embodiments of the invention.

Each container 10 may be modular and reusable enabling the customer to remove and add containers 10 to a stack according to his needs, where the customer can use the containers instead of plastic bags to contain and sort products therein.

The customer may place products in the containers 10 and add containers 10 as he shops according to his needs and then empty the containers 10 one at a time at the cashier station to pass the products therein through the cashier station, where the cashier puts the product that is scanned/read into a similar empty container 10, thereby allowing saving crucial time, usually wasted at the cashier station. By that process, the products may be scanned and packed at the same time by the cashier, without using plastic bags or involving the customer in the packing process. Once a first container 10 is scanned and filled, the next container 10 may be placed on the cashier's station to follow the same process as the one before. Once all products in all containers have been scanned and paid for, the customer may use the containers 10 as bags to place the purchased products therein, and then use the containers 10 to put the purchased products in the customer's car trunk and/or to carry the products using the containers 10 handles, for example.

According to these embodiments, the system 1000 may comprise the shopping cart 100 and at least one modular reusable container 10.

According to some embodiments of the invention, the customer may be able to add and remove containers 10 to and from the shopping cart 100 according to his needs, where the containers 10 are modular enabling to stack the containers 10 together either by piling them one on top of another creating columns (e.g. B1, B2 and B3, see FIG. 2) and/or by coupling them to one another along substantially the same plane in a compacted manner creating rows (e.g. A1 and A2, see FIG. 2).

The containers 10 may be stacked together in a manner that allows the customer to easily add and remove containers 10 to and from the stack. The stack may comprise at least one row A1 and/or at least one column B1.

According to some embodiments of the invention, the containers 10 may be made from solid durable and/or waterproof materials that are rigid enough to substantially maintain their curved shape throughout their shelf life. The containers 10 may be made from, for example, plastic, metal, perspex and the like.

Additionally, the curvature of the container's 10 walls creating the containers' 10 shape may be designed and shaped in a manner that enables each container's 10 compatibility to another container 10 that is placed adjacent to the first. This compatibility may be manifested in a shape that has protruding surfaces along parts of the surface of the container's 10 walls and niches in the other parts of the container's 10 walls. Each protruding part of the container 10 may be suited to engage with the sunken niches parts of an adjacent container 10 in an interlocking manner.

According to some embodiments of the invention, as illustrated in FIG. 2, the shopping cart 100 may be customized in its design, to suit a specific design of the containers 10 and to allow holding the containers 10 in a stabilized manner and/or in a manner that enables fastening to at least some of the containers 10 mounted thereon, to prevent the stacked containers 10 from being shaken or fall from the stack while the shopping cart 100 is rolled through the shopping facility by the customer.

For example, as illustrated in FIG. 2, the shopping cart 100 may comprise:
a frame 111 (e.g. of a standard shopping cart) comprising the wheels;
a base 110 mounted on the frame 111;
handle-frame 130 mounted to the frame 111 and base 110, enabling the
customer to roll the cart 100 by pushing the handle-frame 130 part designed for that purpose; and
at least one support 120 stretching along the handle-frame 130 and connecting to the base 110.

According to some embodiments of the invention, the support 120 may be designed according to the design of the containers 10 to allow the containers 10 of the stack that are adjacent to the support 120 to be properly supported by the support 120. For example, as illustrated in FIG. 2, the curvature of the surface of the support 120 may be compatible to the curvature of the surface of the containers 10 that are adjacent to the support 120 in a manner that allows those adjacent curvatures to engage.

Additionally, fastening means 20 such as clips, screws or any other known fastening means 20 may be added to the system 1000 either to enable to further fastening of the upper and adjacent container 10 in the stack to the support 120 and/or to enable fastening adjacent containers 10 to one another. Additionally or alternatively, the fastening means 20 may be attached to the walls 11 of the containers 10 enabling to attach adjacent containers 10 in a row A1 to one another. These fastening means 20 may be, for example Velcro strips attached to the external sides of the container's 10 wall 11.

According to some embodiments of the invention, a second support 120 structured from the opposing side of the base 110 (opposite to the side of the first support 120) may be added to hold the containers 10 of the stack and to further facilitate in preventing the containers 10 in the stack from falling or shaking.

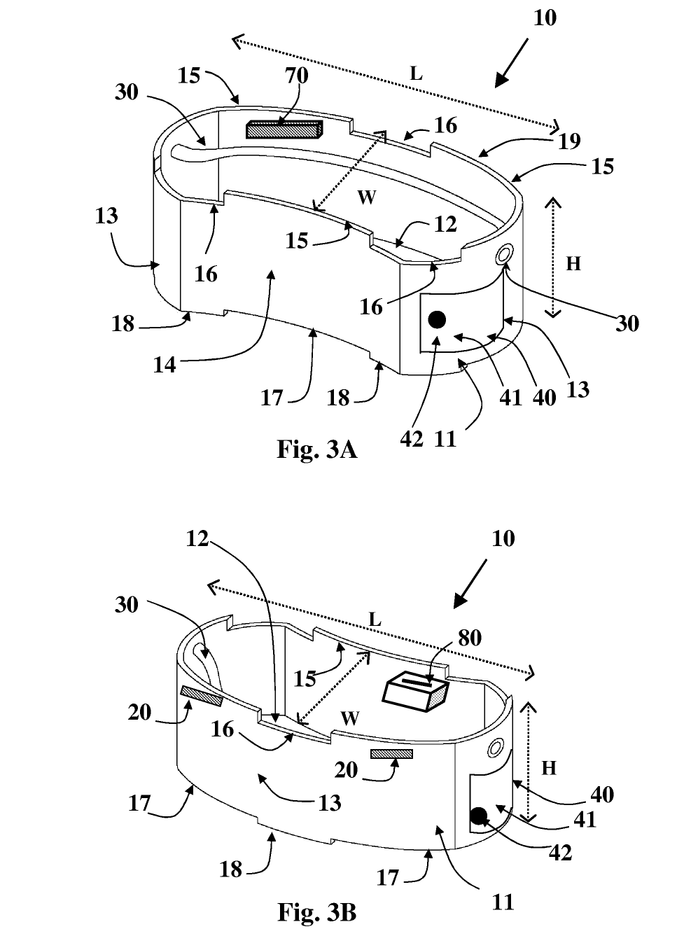

FIG. 3A and FIG. 3B are schematic illustrations of a front and a back view if a modular reusable container 10, according to some embodiments of the invention. FIG. 3A shows the frontal isometric view of the container 10, where FIG. 3B, show the back isometric view respectively.

According to these embodiments, the container 10 may comprise a wall 11 having a defined upper rim 19 and a floor 12 integrally connected to the other side of the wall 11 (the side opposite to the upper rim 19).

The wall 11 of the container 10 may be curved in such a manner that the wall 11 defines protruding parts 13 and sunken parts 14. The floor 12 shape may correspond to the curvature lines of the cross section of the wall 11, as illustrated in FIG. 3A and FIG. 3B.

For example, as illustrated in FIG. 2, FIG. 3A and FIG. 3B, the wall 11 of the container 10 may be kidney shaped where two protruding parts 13 at one side of the container 10 (referred to herein as “the front side”) create a sunken part 14 there between and the other side of the wall 11 (referred to herein as “the back side”) is also a protruding part 13 integrally connected with the other two protruding parts 13. The sunken part 14 of each container 10 may receive the back protruding part 13 of another container 10 that is placed adjacent to it along the row A1 or A2, as illustrated in FIG. 2. The shape of the containers 10 may allow them to engage to one another in a row in an interlocking manner to allow a stack of interlocked row(s) of containers 10 to be compacted into a stable stack in the shopping cart 100 to prevent the containers 10 from falling or being shaken when rolled in the shopping cart 100.

Additionally, the bottom of the container 10 (e.g. the external side of the floor 12) may also include slits or sockets that can be received by corresponding protruding tracks or bulges situated at the base 110 of the shopping cart 100.

According to some embodiments of the invention, as illustrated in FIG. 2 and FIG. 3A, the upper rim 19 of each container 10 may have parts of different height, where the rim 19 comprises protrusions 15 and niches 16. The other edge of the wall 11 of each container 10 may comprise corresponding protrusions 18 and niches 17, which are situated opposite to the protrusions 15 and niches 16 of the upper rim 19 in an alternating manner so that the containers 10 can be placed one on top of the other where the front side of each container 10 faces the same direction as the front side of a container 10 that is adjacently placed on top of it creating a column B1, B2 or B3, as illustrated in FIG. 2, where the lower protrusions 18 of the upper container 10 are received by the upper niches 16 of the lower container 10 and the lower niches 17 of the upper container 10 receive the protrusions 15 of the lower container in an interlocking manner.

According to some embodiments of the invention, as illustrated in FIG. 2, FIG. 3A and FIG. 3B, at least some of the containers 10 may comprise at least one opening 40 situated at one of the sides of the container 10 that faces the external side of the stack when placed in the cart 100, to allow the customer to insert products into the container 10 through the opening 40, even when the container's 10 upper opening is covered by another container 10 placed thereon. Additionally, as illustrated in FIG. 3A and FIG. 3B, the container 10 may also comprise a door 41 attached to the opening 40, which may allow the customer to close and open the opening 40 according to his needs and desire. The door 41 may also have a door-handle 42.

According to some embodiments of the invention, as illustrated in FIG. 3A and FIG. 3B, at least some of the containers 10 may comprise at least one handle 30 to allow the customer to carry the container 10 by holding the handle 30, when removing the container 10 from the stack at the shopping cart 100 or when placing the container 10 on the cart 100 or stack. Each handle 30 may connect to the wall 11 of the container 10 through any connecting means 31 known in the art and may be situated at the inner part of the container 10 (e.g. adjacent to the inner side of the wall 11).

According to some embodiments of the invention, as illustrated in FIG. 3A, at least some of the containers 10 may comprise barcode reader 70, which is a device that can read the barcode indicated on products in the shopping facility. This may help save precious time in standing at the cashier station, where the cashier has to do the scanning for each customer. To pay, the cashier may only be required to read the data from the barcode readers 70 of the containers 10. Additionally or alternatively, each reader 70 may enable the customer to input his/her credit card details so that the charging may be carried out automatically and electronically saving the standing in line at the cashier station altogether.

Additionally, the containers 10, suited to modularly be mounted to and on one another, may be of different sizes enabling to modify the size of each container 10 piled to the stack in the shopping cart 100, to the type and size of the products it can contain. As illustrated in FIG. 2, FIG. 3A and FIG. 2B, each container 10 may have a predefined height “H”, width “W” and length “L”, where, for instance, some of the containers 10 may have one measure of width and the other another measure of width while all containers have the same height and length H and L. This may allow placing containers 10 of different widths in the same row A1 adjacent to one another while still interlocking with one another due to their suitable shape (protruding and sunken parts 13 and 14 respectively) and the equal Ls and Hs. As another example, each row A1 or A2 may contain containers 10 of the same height “H” where the H of one row A1 is different from the H of the containers in the other row A2, while the Ls and the Ws of all the containers 10 in the stack are the same.

According to some embodiments of the invention, at least some of the containers 10 may also be used as an advertising tool, where the containers 10 may carry advertising content (e.g. text or graphics) thereon. The advertisements may either be imprinted on the containers in the manufacturing process, adhered to the outer surface of the containers' 10 walls 11 or be painted and/shaped according to a color and/or shape associated with an advertiser or a product.

According to some embodiments of the invention, the shopping facility may place a large amount of containers 10 and compatible shopping carts 100 for customers to rent, where either the carts 100, the containers 10 or all may comprises a mechanism 80, as illustrated in FIG. 2 and FIG. 3B, for receiving coins that allow renting the container 10 and/or the cart 100 by enabling to release them from a connecting mechanism that hold them one connected to the other or to a post, as known in the art for renting of standard shopping carts 100.

According to some embodiments of the invention, the bottom part of each container 10 may be smaller in area of its cross section than the area of the upper part, preferably in a continuous manner so that the walls 11 of the container 10 are tilted outwardly from the base onwards, to allow compactly inserting of a first container into a second container to stack them one inside the other for storage.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A system 1000 comprising a shopping cart 100 and a multiplicity of containers 10, wherein said containers 10 are mounted on said cart 100 and removed from said cart 100 by a customer, according to the customer's needs,
wherein said containers 10 are reusable and modular enabling to engage with one another in a compact manner creating a stack of at least two rows and at least two columns of containers 10,
wherein each of said containers 10 comprises a wall 11 and a floor 12 integrally connected to said wall 11, wherein said wall 11 comprises protruding parts 13 and at least one sunken part 14, and
wherein said at least one sunken part 14 of a first container 10 enables receiving at least one of the protruding parts 13 of a second container 10 when said containers 10 are placed adjacent to one another in a row, thereby enabling the adjacent containers 10 to engage in an interlocking manner when placed adjacent to one another as the stack in the shopping cart 100.

2. The system 1000 of claim 1, wherein each container 10 has an upper rim 19 defined by the main opening of the container, and
wherein each container 10 further comprises niches 17, which are situated at the lower edge of the container 10, opposite to said rim 19, wherein said niches 17 enable interlocking two adjacent containers 10 placed one on top of the other in an opposite direction.

3. The system 1000 of claim 2, wherein each pair in said stack of adjacent rows of containers 10 placed one on top of the other, has containers 10 that are facing opposite directions alternatively along the stack, wherein the containers 10 of one row face one direction and the container 10 of the adjacent row face the opposite direction.

4. The system 1000 of claim 1, wherein said wall 11 of each container 10 is curved where the protruding parts 13 and the at least one sunken part 14 are defined by said curve, wherein said wall 11 defines an upper rim 19, which is curved according to the curvature of the wall 11,
wherein said at least one sunken part 14 of each container 10 enables receiving at least one of the protruding parts 13 of another container 10 when said containers 10 are placed adjacent to one another, thereby enabling the adjacent containers 10 to engage in an interlocking manner.

5. The system 1000 of claim 4, wherein said shopping cart 100 comprises:
a frame 111 comprising the wheels;
a base 110 mounted on the frame 111;
handle-frame 130 mounted to the frame 111 and base 110, enabling the customer to roll the shopping cart 100 by pushing the handle-frame 130; and
at least one support 120 stretching along the handle-frame 130 and connecting to the base 110, and
wherein the curvature of the surface of the support 120 is compatible to the curvature of the surface of the containers 10 that are adjacent to the support 120 in a manner that allows those adjacent curvatures of the containers 10 and support 120 to engage.

6. The system 1000 of claim 4, wherein the curvature of the wall 11 of each container 10 is kidney shaped.

7. The system 1000 of claim 1, wherein each container 10 further comprises at least one handle 30 connected thereto enabling the customer to hold the container 10 with said at least one handle 30.

8. The system 1000 of claim 1, wherein each container 10 is made from solid materials enabling to maintain its shape and hold products therein.

9. The system 1000 of claim 1, wherein each container 10 is made from solid and waterproof materials.

10. The system 1000 of claim 1, wherein said containers 10 enable the customer to add and remove containers 10 to and from the shopping cart 100 according to his needs, wherein the modular containers 10 enabling the customer to one of: pile them one on top of another creating columns or couple place same adjacent to one another in a compacted manner creating rows.

11. The system 1000 of claim 1, wherein said containers 10 have different sizes enabling the customer to select the size of the container 10 according to his needs and stacking and coupling different sizes of containers 10 to one another in a compacted manner.

12. The system 1000 of claim 1, wherein at least some of said containers 10 comprise barcode reader 70, which is a device that enables reading the barcode indicated on products in the shopping facility.

13. The system 1000 of claim 12, wherein said barcode reader 70 enables the customer to input his credit card details so that the charging for the customer's products placed in the containers 10 is carried out automatically and electronically through said reader 70.

14. The system 1000 of claim 1 further comprises fastening means 20 that enable to fasten containers 10 that are situated adjacent to the shopping cart 100 to said cart 100.

15. The system of claim 14, wherein said fastening means 20 are attached to the walls 11 of the containers 10 enabling to attach adjacent containers 10 in a row to one another.

16. The system 1000 of claim 1, wherein at least some of the containers 10 comprise at least one opening 40 situated at one of the sides of the container 10 that faces the external side of the stack when placed in the cart 100, to allow the customer to insert products into the container 10 through said opening 40.

17. The system 1000 of claim 15, wherein said container 10 further comprises a door 41 attached to said opening 40, which allows the customer to close and open the opening 40 according to his needs.

18. The system 1000 of claim 1, wherein the bottom of each container 10 further comprises slits and the base 110 of the shopping cart 100 further comprises corresponding protruding tracks wherein the slits enable receiving the protruding tracks and thereby hold the bottom rows of containers 10 placed on said base 110.

19. The system 1000 of claim 1, wherein at least some of said containers 10 are used as an advertising tool, and wherein the containers 10 carry advertising content thereon.

20. The system 1000 of claim 1, wherein at least one of the containers 10 further comprises a mechanism 80 for receiving coins that allow renting the container 10.

21. The system 1000 of claim 1, wherein the walls 11 of each said container 10 are tilted outwardly from the base onwards, to allow compactly inserting of a first container into a second container to stack them one inside the other for storage.

22. A multiplicity of containers 10, wherein said containers 10 can be mounted on a shopping cart 100 and removed from said cart 100, according to a customer's needs,
wherein said containers 10 are reusable and modular enabling to engage with one another in a compacted manner as a stack, and
wherein said containers 10 are shaped in such a manner that enables them to engage when placed adjacent to one another in the shopping cart 100.
